(19) United States
(12) Patent Application Publication
(10) Pub. No.: US 2003/0213903 A1
(43) Pub. Date: Nov. 20, 2003

(54) Method and apparatus for separating or capturing ions, and ion detection method and apparatus utilizing the same

(76) Inventors: Satoshi Ichimura, Hitachi (JP); Tadashi Sato, Akita (JP); Katsutoshi Tsuchiya, Hitachi (JP)

Correspondence Address: MATTINGLY, STANGER & MALUR, P.C., 1800 DIAGONAL ROAD, SUITE 370, ALEXANDRIA, VA, 22314, US

(21) Appl. No.: 10/438,068

(22) Filed: May 15, 2003

(30) Foreign Application Priority Data
May 16, 2002 (JP) 2002-140885

(51) Int. Cl. H01J 49/00

(52) U.S. Cl. 250/282

(57) ABSTRACT

A new method for spatially separating and capturing ions type of different ionic mobility in a fluid medium, and an ion detection method and apparatus capable of newly utilizing this separating and capture method for high-sensitivity and high-resolution detection of ion species in tiny amounts within a fluid medium according to their ionic mobility. By overlapping an electrical field in the same direction as the flow direction, in a location with a decelerating flow having multiple ions, those ion species (ion 2, ion 3) having the specified range of ionic mobility, are captured at a position (z2, z3 each) where a drift speed (vd2, vd3 each) determined by the ionic mobility of each ion species and electrical field intensity is balanced by a flow speed (vf) changing in the flow direction of that flow location; and in this way ion species with different ionic mobility in a range specified by the balance position are spatially isolated in that direction and, captured in their respective flow directions.

### BACKGROUND OF THE INVENTION

1. Field of the Invention

The present invention relates to an ion separating and capturing method and apparatus and an ion detection method and apparatus utilizing the same, and in particular relates to a preferable method and apparatus for separating or capturing ions by utilizing the difference in ionic mobility within a fluid medium, and more particularly relates to an ion separating and capturing method and apparatus and an ion detection method and apparatus utilizing the same.

2. Description of Related Art

Ion mobility spectrometry is known in the related art as a method for detecting ions according to (their) ionic mobility by utilizing the difference in ionic mobility in the fluid medium. An ion mobility spectrometry method of the related art is disclosed for example in JP-A-264505/1993. In the ion mobility spectrometry method of the related art, the drift speeds of the different types of ions along the direction of the electrical field in a gas fluid medium applied with a specified electrical field called a drift space, are utilized to determine the mobility of each ion and ions are detected according to their ionic mobility in the method described next.

A supply point for supplying ions to the drift space applied with a specific electrical field, and a detection point for detecting ions separated a specified distance from the supply point in the direction of the electrical field drift space are first established. Ion parent clusters containing different types of ion from an ion source are supplied to the supply point from a specified point in time over a specified time period. The quantity of ions moving from the supply point to the detection point in the drift space along the electrical field is then detected at the detection position at each time point. Waveform data on the ion quantity at the detection time is obtained in this way. The ion quantity peak value and its detection time are obtained from this waveform data. The ion mobility time when ions move a specified distance is determined from the detection time and ion supply time point as well as the time; the ion drift speed is determined from the movement time and specified distance; and the ionic mobility is determined from this drift speed and the specified electrical field. Consequently, the ion species contained in the ion parent cluster can then be identified according to the ionic mobility.

However, in order to detect extremely tiny quantities of explosive vapor within the air, the sample air containing the explosive vapor must be negatively ionized at the ion source. These negative ions must then be detected according to their mobility by the ion mobility spectrometry method. The oxygen contained in the sample air is also negatively ionized at that time so that an extremely large amount of negatively ionized oxygen is generated at the ion source compared to the negatively ionized explosive vapor. The ion parent cluster supplied in the drift space from the ion source therefore also contains an extremely large of negatively ionized oxygen compared to the negatively ionized explosive vapor.

The technology of the related art has the problem that when this negatively ionized oxygen is present in extremely large amounts in the ion parent cluster, detection of other ion species present in very tiny amounts becomes extremely difficult with this ion mobility spectrometry method.

Namely, when ion parent clusters are supplied to the drift space from the ion source, the ion species mixed together in the interior of the ion parent cluster are gradually separated according to differences in individual drift speed during movement along the drift direction. However, at the stage where separation has not occurred right after being supplied, the ions are subjected to a mutually repulsive force from a self-generated electrical field formed by the spatial charge of all ions contained in the ion parent cluster so that the ion parent cluster spreads out spatially. This spatial widening continues until the self-generated electrical field forming the spatial charge has become sufficiently small relative to the drift electrical field, and all ion species contained in the ion parent cluster also spatially widened to the same extent. When ion species are present in extremely large quantities in the ion parent cluster, the spatial widening of the ion parent cluster is determined by the ion species' quantity. This spatial widening according to quantity causes a drastic drop in spatial density in other types of ions present in tiny amounts in the ion parent cluster. This drop in spatial density appears as a drastic decline in the peak value of the ion quantity detected at the detection point making it nearly impossible to detect the ion species.

Therefore the related art has the problem that using the ion mobility spectrometry method to detect ion species present in small amounts is extremely difficult when other ion species are present in extremely large amounts within the ion parent cluster.

### SUMMARY OF THE INVENTION

In view of the above problems with the related art, the present invention has an object of providing a new method and apparatus for spatially separating and capturing ion species of different ionic mobility in a fluid medium and further of providing an ion detection method and apparatus capable of high sensitivity and high macromolecular resolution according to the ionic mobility of ion species present in tiny amounts within the fluid medium.

To achieve the above objects, in the method and apparatus of the present invention, by overlapping an electrical field in the same direction as the flow direction, in a location with a decelerating flow having multiple ion species, those ion species within a specified range of ionic mobility, are captured at a position where a drift speed determined by the ionic mobility of each ion species and the electrical field intensity matches the flow speed changing in the flow direction at that flow location; and in this way ion species with different ionic mobility in a range specified by that matching position are spatially isolated in that direction and also captured in their respective flow directions. By also boosting or lowering the intensity of the electrical field, the trapped ions are made to move upstream or downstream of the flow location and detected by ion detectors installed upstream or downstream of the flow location so that ions of different ionic mobility are separated as a function of time according to that mobility and detected.

### BRIEF DESCRIPTION OF THE DRAWINGS

FIG. 1 is a graph of essential sections of the ion detection apparatus of the first embodiment of the present invention;

FIG. 2 is a diagram for describing the ion separation and capture function in the slowing flow field of the invention;

FIG. 3 is a diagram for describing the ion detecting function in the ion detection apparatus of FIG. 1;

FIG. 4 is a graph of essential sections of the ion detection apparatus of the second embodiment of the present invention; and

FIG. 5 is a diagram for describing the ion detecting function in the ion detection apparatus.

### DETAILED DESCRIPTION OF THE PREFERRED EMBODIMENTS

The preferred embodiments of the present invention are described next while referring to the accompanying drawings.

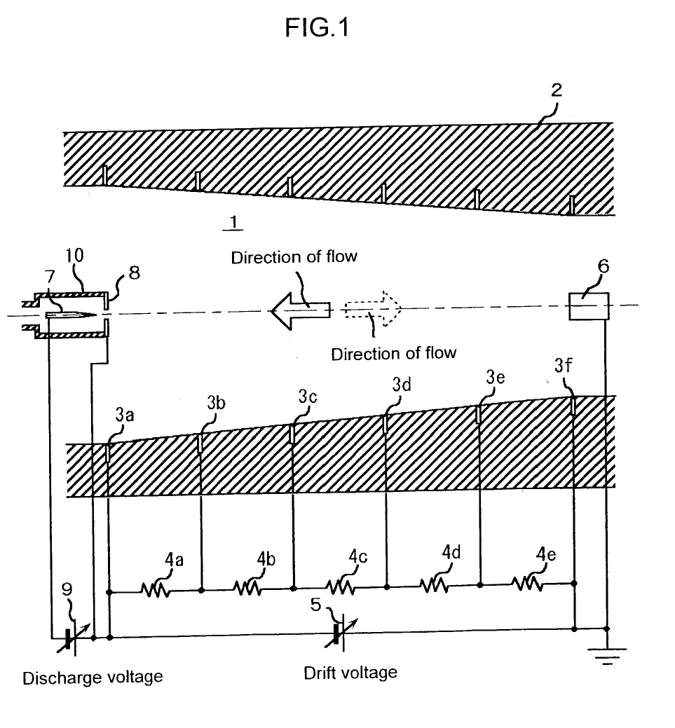

FIG. 1 is a graph of essential sections of the ion detection apparatus of the first embodiment of the present invention. The ion detection apparatus of the first embodiment contains a drift tube 2 forming a flow path in the interior. The drift tube 2 is made of an insulating material such as ceramic. The flow path has an axially symmetric shape on the left and right of the drawing. The flow path cross sectional area gradually increases from right to left in the figure. When a fixed quantity of fluid medium is made to flow from right to left in the figure in other words, in the direction shown by the solid line arrow in the figure, a slowing flow field 1 is formed in the range where the flow path cross sectional area steadily increases within the drift tube 2.

Multiple ring-shaped field electrodes 3a, 3b, 3c, 3d, 3e and 3f are installed in order from the left along the flow path of the drift tube 2. Resistors are connected between the adjacent field electrodes. More specifically, a resistor 4a is connected between the field electrodes 3a and 3b, a resistor 4b is connected between the field electrodes 3b and 3c, a resistor 4c is connected between the field electrodes 3c and 3d, a resistor 4d is connected between the field electrodes 3d and 3e, and a resistor 4e is connected to the field electrodes 3e and 3f. One end of the direct current power supply 5 is connected to the field electrode 3a and the other end is connected to the resistor 3f. When the direct current power supply 5 applies a drift voltage, resistor values are selected so that the multiple field electrodes axially form a uniform electrical field along the center axis of the flow path.

Sections in the ion detection apparatus described above comprised the ion separation and capturing apparatus. Additional sections making up the ion detection apparatus are described next.

An ion source is installed on the immediate left of the range formed by the slowing flow field 1 on the center axis of the flow path formed by the drift tube 2. The ion source is composed of an ion source wall 10, a pin-shaped electrode 7, and a flat plate electrode 8. The ion source wall 10 is made of insulating material such as ceramic, and the sample gas flows into the interior from the left side of the figure. When a discharge voltage is applied between the needle electrode 7 and the flat plate electrode 8 by the direct current power supply 9, a corona voltage is generated across these electrodes, and a portion of the sample gas supplied to the interior of the ion source is ionized. Depending on the polarity of the applied direct current voltage, either negatively or positively polarized ions are supplied to the slowing flow field 1 from holes in the center of the flat plate electrode 8.

An ion detector 6 is installed on the immediate right of the range formed by the slowing flow field 1 on the center axis of the flow path formed by the drift tube 2. The ion detector 6 is composed of a Faraday plate for detecting ion current and detects the quantity of ions flowing in to the detection surface bordering on the slowing flow field 1.

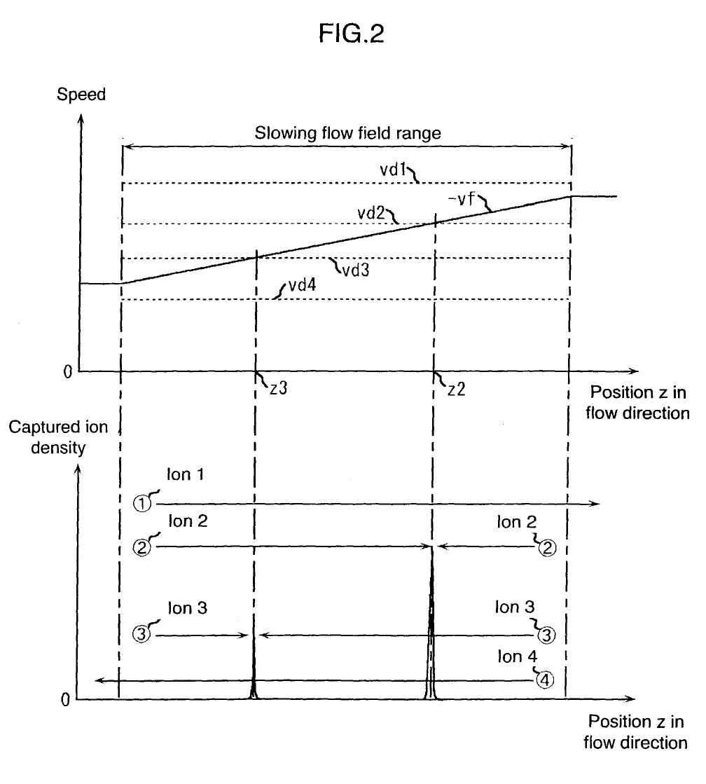

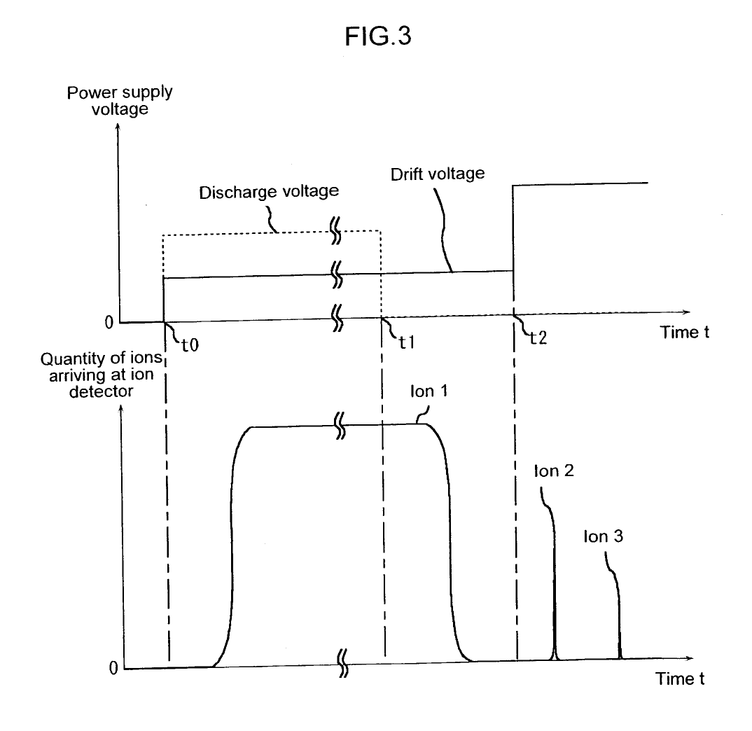

The embodiment of the ion detection apparatus was comprised as described above. The functions of the ion detection apparatus are next described while referring to FIG. 2 and FIG. 3 as well as FIG. 1. The ion separating and capturing function of the apparatus is first described and then the ion detection function is explained.

The slowing flow field 1 is first formed by flowing a fixed amount of gas fluid medium from right to left in the interior of the drift tube 2. The flow of the fluid medium along the center axis of the flow path at this time matches the axial center of the flow path. Here, the setting of the positive z coordinates (flow and reverse flow) in the flow direction is described next. When the flow speed along the z direction of the fluid medium along the interior of the drift tube 2 is set as vf, then the −vf gradually diminishes in the flow towards the slowing flow field 1 range as shown by the solid line on the upper side of FIG. 2.

When a drift voltage is applied by the direct current power supply 5, a suitable resistance value is selected from the resistors 4a through 4e, a uniform drift electrical field is overlapped in the same direction as the flow direction, at the slowing flow field 1 by the electrodes 3a to 3f. The drift electrical field at the slowing flow field 1 is set towards the dotted line of FIG. 1 for the ion drift having specified polarity of either positive or negative. In other words, set towards the direction of the positive z coordinates.

The movement of each ion when for example, four types of ions (ion 1, ion 2, ion 3 and ion 4 in the order of largest ion mobility) having a specified polarity are supplied from the ion source is described next. The values of the drift speeds vd1, vd2, vd3 and vd4 at the slowing flow field from applying a specified drift electrical field to the slowing flow field of each ion are shown by the dotted lines at the respective flow direction positions on the upper part of FIG. 2.

The ions shift to the slowing flow field 1 at a composite speed vd+vf of the flow speed vf and drift speed vd. The ion 1 has a vd+vf>0 at any flow direction position so that the ion 1 always moves towards the z positive direction as shown on the lower side of FIG. 2. In other words, the ion 1 moves upstream of slowing flow field 1 and is finally ejected outside from the upstream side of slowing flow field 1. The ion 4 has a vd+vf<0 at any flow direction position so that the ion always moves towards the z negative direction. In other words, the ion 4 moves upstream of slowing flow field 1 and is finally ejected outside from the downstream side of slowing flow field 1. In contrast, the ion 2 and ion 3 are present at a balanced position in the slowing flow field 1 range where the flow speed and drift speed match, namely at a position z2, z3 where the composite speed (vd+vf) is 0. When at a position downstream of the balance position, vd+vf>0 so the ions shift upstream, and when at a position upstream of the balance position, vd +vf<0 so the ions move downstream and are consequently each captured at flow direction positions z2, z3.

The sections that make up the ion separating and detecting portions of the ion detection apparatus of the present embodiment in this way spatially separate ion species having different ionic mobility within a specified range in a direction flowing to the slowing flow field, and also capture these ions in their respective specified flow direction positions.

The detection function of the ion detection apparatus of the present embodiment is described next. For the purposes of simplicity, an example is used where explosive vapors contained in the air are negatively ionized and detected.

The slowing flow field 1 is first formed by flowing gas fluid medium from right to left in fixed amounts in the drift tube 2 of FIG. 1. The gas fluid medium may for example be an inert gas such as argon gas that is difficult to negatively ionize. Air containing explosive vapors may be used as the sample gas and supplied to the ion source.

In this state, a specified drift voltage and a discharge voltage are generated by the direct current power source 5 and direct current power source 9 from the time shown as t0 in the chart in FIG. 3. The drift voltage and discharge voltage time settings are respectively shown by the straight line and broken line on the upper side of FIG. 3.

A negative ion separating and capture effect is made to occur at the slowing flow field 1 by applying a specified drift voltage, and ions are generated in the ion source at the same time by applying a discharge voltage. The negative ions among these generated ions are supplied to the slowing flow field 1. While an extremely large quantity of negative oxygen ions are present among the negative ions supplied from the ion source, there are very few negative ions formed from explosive vapor. Though the quantities depend on the type of explosive matter and ambient environmental conditions, the quantity of negative oxygen ions supplied from the ion source is several thousand to several hundred million times higher than the number of negative ions formed from explosive vapor.

However, the mobility of the negative oxygen ions is generally larger than the mobility of negative ions formed from explosive vapor. By therefore applying a specified drift voltage at a suitable value, the ion 1 (negative oxygen ion), and the ion 2 and ion 3 formed from explosive vapor can be identified as ions with different ionic mobility as described in the explanation of the ion separation and capture function previously given for FIG. 2. The negative oxygen ions (ion 1) supplied in extremely large amounts from the ion source at this time, move upstream towards the slowing flow field 1. These ions are delayed just by the time required to move from time t0, and arrive at the ion detector 6 installed on the upstream side. This state is shown on the lower side of FIG. 3.

The explosive vapor negative ions (ion 2 and ion 3) supplied to the slowing flow field 1 from the ion source are however captured at the respective specified positions (z2, z3 in FIG. 2) used as slowing flow fields 1 for capturing ions. The number of accumulated ions therefore increases in the period that negative ions are supplied to the slowing flow field 1 from the ion source and trapped (captured) at the capture positions.

After a specified time has elapsed and the quantity of ions 2 and ions 3 has sufficiently accumulated at the trap (capture) positions, the discharge voltage generated from the direct current power supply 9 is set to zero, and the generation of ions by the ion source and supply of negative ions to the slowing flow fields 1 stops at the time shown by t1 in the chart in FIG. 3. The negative oxygen ions (ion 1) still remaining in the slowing flow fields 1 then move towards the upstream side, and after the time needed to eject all ions from the upstream side has elapsed, no more negative ions arrive at the ion detector 6. The negative ions (ion 2 and ion 3) formed from explosive vapor however continue to move towards the trap (capture) positions.

A specified amount of time is used for movement of negative ions (ion 2 and ion 3) formed from explosive vapor, and after these ions have sufficiently accumulated at the specific capture positions, the drift voltage is increased to a specified value at the time shown by t2 in the chart of FIG. 3. The size of that drift voltage is a level sufficient to raise the drift speed to make the composite speed (flow speed and each drift speed) a positive value for the negative ions (ion 2 and ion 3) at any position of the slowing flow field 1. The negative ions (ion 2 and ion 3) formed from explosive vapor in this way start to move in an upstream flow from the capture positions. After a specified time has then elapsed, the ions arrive at the ion detector 6 in the order of high ionic mobility or in other words in order from ion 2, ion 3. The ion quantity of these arriving ions is detected at each time (point) by the ion detector 6. Waveform data on the ion quantity detected at each time in this way is acquired. The peak value of the ion quantity and its detection time are found from this waveform data, and the ion movement time from the capture position to the ion detector 6 is found from the detection time and the ion movement start time.

On the other hand, if ions have a certain amount of ionic mobility, their capture position at the ion slowing flow field can be established from their ionic mobility, flow distribution at the slowing flow field, and the drift voltage value applied for separating and capturing ions. The ion movement speed at an optional flow direction position can be determined from their ionic mobility, flow distribution at the slowing flow field, and the drift voltage value applied to move the ions in an upstream flow. The ion movement time from the capture position until arrival at the ion detector 6 can therefore be found as function of the ionic mobility. The ion species can therefore be identified according to its ionic mobility by using the movement time.

As described above, in applications where negatively ionizing explosive vapors contained in air and detecting ions in the ion detection apparatus of the present embodiment, while negative oxygen ions supplied in extremely large quantities from the ion source are allowed to continuously flow to the slowing flow fields, the negative ions formed from explosive vapor can be accumulated at the specified slowing flow fields. Ion species with different ionic mobility are then spatially separated so there is no effect on the spatial charge of other ions, and the ion parent cluster spatially expands according to the individual spatial charge. The tinier the amount of ions, the less the extent of that ion spread, so that there is no drastic drop in the ion spatial density. So if the ions are made to move upstream by increasing the drift voltage and then detected by ion detectors installed at upstream locations, an ion quantity waveform having a sharp peak value versus the time can then be obtained. Therefore, even extremely tiny amounts of ions can be detected with high sensitivity and high resolution.

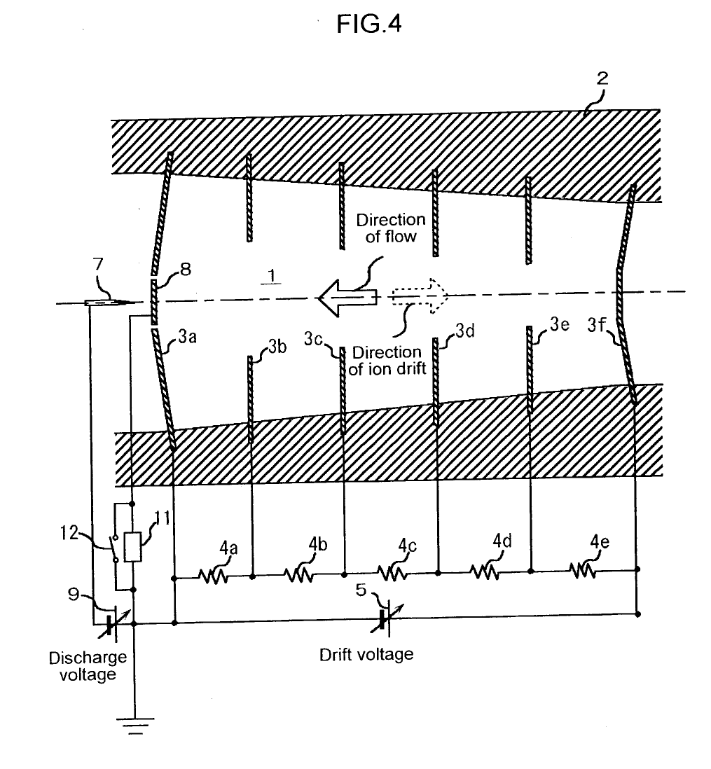

Another embodiment of the present invention is described next. FIG. 4 is a graph showing essential sections of the ion detection apparatus of the second embodiment of the present invention.

The ion detection apparatus of the present embodiment contains a drift tube 2 the same as in the first embodiment. The drift tube 2 is made of an insulating material such as ceramic. The flow path has an axially symmetric shape on both left and right of the drawing. The flow path cross sectional area gradually increases from right to left in the figure. When a fixed quantity of fluid medium is made to flow from right to left in the figure in other words, the direction shown by the solid line arrow in the figure, a slowing flow field 1 is formed in the range where the flow path cross sectional area steadily increases within the drift tube 2.

Multiple ring-shaped field electrodes 3a, 3b, 3c, 3d, 3e and 3f are installed in order from the left along the flow path of the drift tube 2. These field electrodes 3a, 3b, 3c, 3d, 3e and 3f are formed of mesh material to allow the fluid medium (or air) to pass easily. Resistors are connected between the adjacent field electrodes. More specifically, a resistor 4a is connected between the field electrodes 3a and 3b, a resistor 4b is connected between the field electrodes 3b and 3c, a resistor 4c is connected between the field electrodes 3c and 3d, a resistor 4d is connected between the field electrodes 3d and 3e, and a resistor 4e is connected to the field electrodes 3e and 3f. One end of the direct current power supply 5 is connected to the field electrode 3a and the other end is connected to the resistor 3f. When the direct current power supply 5 applies a drift voltage, resistor values are selected from the resistors so that the multiple field electrodes axially form a uniform electrical field along the center axis of the flow path. Setting a pattern for the multiple field electrodes makes the (uniform electrical potential) surface of the overall electrical field shape of slowing flow field 1 protrude towards the current flow.

The sections of the ion detection apparatus described above comprised the ion separation and capturing apparatus of the present embodiment. Additional sections making up the ion detection apparatus are described next.

An ion generation means is installed on the immediate left of the range formed by the slowing flow field 1 on the center axis of the flow path formed by the drift tube. The ion generation means is composed of a pin-shaped electrode 7 and a flat plate electrode 8. The flat plate electrode 8 is made of mesh material to allow easy passage of the fluid medium. When an external switch 12 on an external section is shorted, a discharge voltage is applied across the pin-shaped electrode 7 and a flat plate electrode 8 by the direct current power supply 9. This discharge voltage causes a corona discharge across these electrodes and depending on the polarity of the direct current voltage that was applied, positive ions or negative ions and electrons pass through the mesh-shaped flat plate electrode 8 and are supplied to the slowing flow field 1.

An ion detector 11 is connected in parallel with the switch 12 between the flat plate electrode 8 and ground potential. The ion current flowing into the flat plate electrode 8 can in this way be detected by the current detector 11 when the switch 12 is open. In other words, the ion detector is composed of a current detector 11 and flat plat electrode 8.

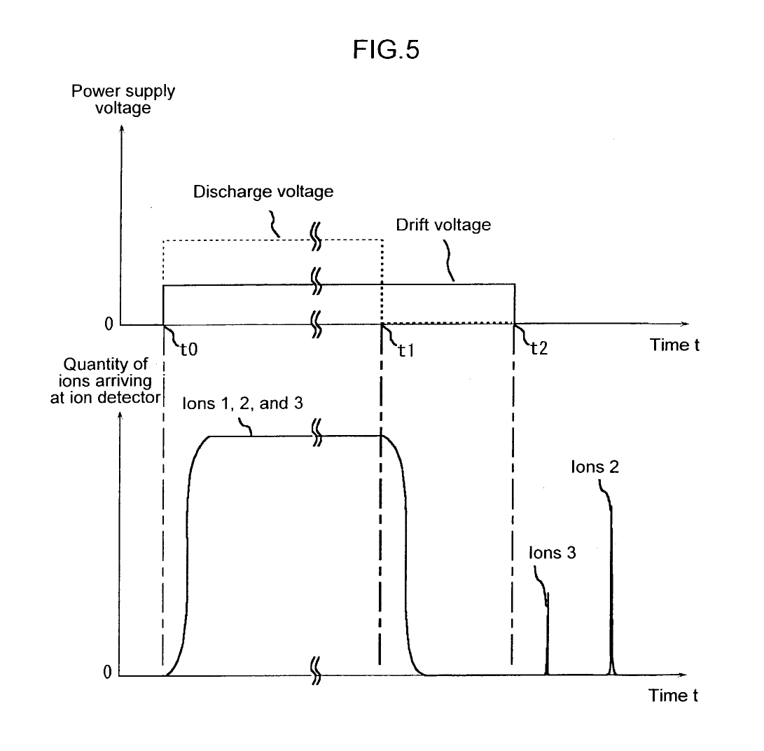

The ion detection apparatus of the present embodiment was comprised as described above. The functions of this ion detection apparatus are next described while referring to FIG. 2 and FIG. 5 as well as FIG. 4. The ion separating and capturing function of the apparatus is first described and then the ion detection function is explained.

The function for separating and capturing of ions in the flow direction of the slowing flow field 1 in the section making up the ion separation and capture apparatus in the present embodiment is identical to the description for the first embodiment and is therefore omitted here. Unlike the first embodiment, the multiple field electrodes 3a, 3b, 3c, 3d, 3e and 3f are formed of mesh material, and by setting these electrodes into respective suitable shapes, when a drift voltage is applied a uniform electrical field is formed axially along the center axis of the flow path. The (uniform electrical potential) surface of that electrical field is formed to protrude towards the current flow. Consequently when ions having a polarity making them subject to capture and detection deviate radially from the center axis, they encounter a static electrical force towards the center axis. Therefore those ions captured in the specified flow direction position of the slowing flow field 1 are also subject to a binding static electrical effect in the radial direction.

The ion detection function of the ion detection apparatus of the present embodiment is described next. For the purposes of simplicity, an example is used where explosive vapors contained in the air are negatively ionized and detected.

The slowing flow field 1 is first formed by flowing a fixed quantity of air containing explosive vapor as the sample gas from right to left inside the drift tube 2 of FIG. 1. The switch 12 is electrically shorted.

In this state, a drift voltage and a discharge voltage at a specified level are generated by the direct current power source 5 and direct current power source 9 from the time shown as t0 in the chart in FIG. 5. The respective times for drift voltages and discharge voltages are shown by the straight line and broken line on the upper part of FIG. 5. Applying a specific drift voltage causes the separating and capture effect on negative ions as described in detail for the first embodiment using FIG. 2. Applying a discharge voltage at this same time makes the ion generation means generate positive and negative ions and electrons and among these ions, just the negative ions and electrons are supplied to the slowing flow field 1. Newly generated negative ions among the negative ions and electrons are supplied to the slowing flow field 1 contain extremely large amounts of negative oxygen ions. In contrast, there are very few negative ions formed from explosive vapor.

Negative oxygen ions generally have a larger ionic mobility than negative ions formed from explosive vapor as previously described. By therefore setting a suitable value for applying the drift voltage; the negative oxygen or ion 1, and the ions formed from explosive vapor or ion 2 and ion 3 can be identified as ions with different ion mobility as in the description of the ion separating and detecting effect used with FIG. 2.

The negative ions generated by the pin-shaped electrode 7 and flat plate electrode 8 move towards the upstream current flow. The ions then pass through the flat plate electrode 8 constituting a portion of the ion detector and flow into the slowing flow field 1 delayed just by the movement time from t0. This state is shown on the lower part of FIG. 3. The negative oxygen ions (ion 1) among these negative ions continuing moving upstream of the slowing flow field 1 and are eventually ejected from the upper side of slowing flow field 1. During this movement, when these ions at that time collide with the explosive vapor contained in the sample gas flowing in the opposite direction, a shift in electrical charges occurs between the negative oxygen ions and explosive vapor, causing the generation of negative explosive vapor ions (ion 2 and ion 3). This phenomenon occurs because the explosive vapor generally has greater electrical negativity than does oxygen.

The negative ions pass the flat plate electrode 8 and are supplied to the slowing flow field 1, or the explosive vapor ions (ion 2 and ion 3) generated from the shift in electrical charges between the negative oxygen ions and explosive vapor are trapped (captured) at the respective slowing flow field 1 positions (z2, z3 in FIG. 2) by the ion capture effect. These ions move to the capture positions while the ion generation means is operating by application of the discharge voltage and are captured there and accumulate thus increasing the quantity of ions.

After a specified time elapses and the quantity of ions 2 and ions 3 has sufficiently accumulated at the trap (capture) positions, the discharge voltage generated from the direct current power supply 9 is set to zero at the time shown by t1 in the chart in FIG. 5, and the generation of ions is stopped. The negative ions remaining on the downstream side of the flat plate electrode 8 move towards the upstream side and when finished passing the flat plate electrode 8, no more negative ions arrive at the ion detector 6. After a specified amount of movement time, the negative oxygen ions (ion 1) are all ejected from the upstream side of the slowing flow field 1. However, the negative ions (ion 2, ion 3) formed from explosive vapor continue moving until arriving at the respective capture positions.

A specified amount of time is used for movement of negative oxygen ions (ion 1) and negative ions (ion 2 and ion 3) formed from explosive vapor, and after there are no more negative oxygen ions at the slowing flow fields, the explosive vapor negative ions are sufficiently accumulated at the specific capture positions, and the drift voltage is set to zero at the time shown by t2 in the chart of FIG. 3. However the switch 12 is opened first and in this way the negative ions (ion 2 and ion 3) formed from explosive vapor start to move downstream from the slowing flow fields. After a specified time has then elapsed, the ions arrive in the order of low ionic mobility or in other words in order from ion 3, ion 2 at the flat plate electrode 8 comprising the ion detector. A portion of these arriving ions flow into the flat plate electrode 8 and that ion quantity is detected at each time (or time-point) by the ion detector 11. Waveform data on the ion quantity detected at each time is in this way acquired. The peak value of the ion quantity and its detection time are found from this waveform data, and the ion movement time from the capture position to the flat plate electrode 8 is found from the detection time and the ion movement start time.

If ions have a certain degree of ionic mobility on the other hand, their capture position at the ion slowing flow field can be established from their ionic mobility, flow distribution at the slowing flow field 1, and the drift voltage value applied for separating and capturing the ions. The ion movement time until arrival at the flat plate electrode 8 can also be found from the flow speed distribution of the slowing flow field and the capture position so that the type of ion can be identified according to its ionic mobility by utilizing the movement time.

Therefore, in the same way as in the first embodiment, in applications in the present embodiment where negatively ionizing explosive vapors contained in air and detecting ions in the ion detection apparatus, while extremely large quantities of negative oxygen ions in the slowing flow fields are allowed to continuously pass; the negative ions formed from explosive vapor can be trapped and accumulated at the specified slowing flow fields. Ion species with different ionic mobility are then spatially separated so there is no effect on the spatial charge of other ions, and the ion parent cluster spatially expands according to the individual spatial charge. The tinier the amount of ions, the less the extent of that ion spread, so that there is no drastic drop in the ion spatial density.

Accordingly, if the ions are made to move downstream by decreasing the drift voltage and then detected by ion detectors installed at downstream locations, an ion quantity waveform having a sharp peak value versus the time can then be obtained. Therefore, even extremely tiny amounts of ions can be detected with high sensitivity and high resolution.

The ion detection apparatus of the present embodiment renders the following effects compared to the apparatus of the first embodiment.

(1) During continuous ion detection the maximum required drift voltage is small. Therefore a small maximum voltage generated by the direct current power supply 5 can be used.

(2) When detecting ions with the ion detector 6, the drift voltage generated by the direct current power supply 5 can be set to zero. Noise on the ion detector signal caused by operation of the direct current power supply 5 can therefore be reduced.

The present invention as described above is capable of spatially separating ion species of different ionic mobility in a flow direction within a specific range in a fluid medium and capturing the ions in their respective flow direction positions. The present invention is also capable of detecting other ion species with high sensitivity and high macromolecular resolution even if present in tiny amounts within the fluid medium.

What is claimed is:

1. Ion separating and capturing method utilizing the difference in ionic mobility within the fluid medium, wherein
ion species possessing ion mobility within a specified range are captured by overlapping said electrical field in the same direction as said flow direction in a slowing flow field containing said multiple ion species, at a position where a drift speed determined by said ionic mobility of said ion species and by the intensity of an electrical field is balanced by a flow speed changing in the direction of current flow, and
said ion species possessing mutually different ionic mobility within a specific range are therefore spatially separated in said current direction, and captured at respective specified flow direction positions.

2. Ion detection method for detecting ion species according to ionic mobility by utilizing the difference in ionic mobility within the fluid medium, wherein
ion species possessing ion mobility within a specified range are captured by overlapping said electrical field in the same direction as said flow direction in a slowing flow field containing said multiple ion species, at a position where a drift speed determined by said ionic mobility of said ion species and by the intensity of an electrical field is balanced by a flow speed changing in the direction of current flow, and
said ion species possessing mutually different ionic mobility within a specific range are therefore spatially separated in said current direction, and
after capturing said ion in respective flow direction positions, said captured ions are moved upstream of said slowing flow field by increasing the intensity of said electrical field and then detected by ion detectors installed upstream of said slowing flow field to detect ions of different ionic mobility in the order of large ionic mobility on downwards.

3. Ion detection method for detecting ion species according to ionic mobility by utilizing the difference in ionic mobility within the fluid medium, wherein
ion species possessing ion mobility within a specified range are captured by overlapping said electrical field in the same direction as said flow direction in a slowing flow field containing said multiple ion species, at a position where a drift speed determined by said ionic mobility of said ion species and by the intensity of an electrical field, balances a flow speed changing in the direction of current flow, and
said ion species possessing mutually different ionic mobility within a specific range are therefore spatially separated in said current direction, and
after capturing said ion in respective flow direction positions, said captured ions are moved downstream of said slowing flow field by decreasing the intensity of said electrical field and then detected by ion detectors installed downstream of said slowing flow field to detect ions of different ionic mobility in the order of small ionic mobility on downwards.

4. Ion separating and capture apparatus comprising a drift tube to allow a fluid medium to flow internally and gradually increase the flow path cross sectional area in the direction of said fluid medium flow, and a means for forming an electrical field in the same direction as said fluid medium flow in said drift tube, wherein
a slowing flow field is formed by making a fixed quantity of fluid medium flow inside said drift tube from the side of said drift tube having a small cross sectional area; and
by overlapping an electrical field made by a field forming means, in the same direction as the current flow at said slowing flow field, said ions within said slowing flow field are captured at a position balancing a drift speed determined by said ionic mobility of said ion species and intensity of said electrical field, with a flow speed changing in the direction of current flow; and
said ion species possessing different ionic mobility within a specific range are in this way spatially separated in said current direction, and are captured at respective specified flow direction positions.

5. An ion detection apparatus comprising a drift tube to allow a fluid medium to flow internally and gradually increase the flow path cross sectional area in the direction of said fluid medium flow, and a means for forming an electrical field in the same direction as said fluid medium flow in said drift tube, a means to supply or generate ions in the interior of said drift tube, and a means for detecting ions installed upstream of said fluid medium flow, wherein
a slowing flow field is formed in the interior of said drift tube by flowing a fixed quantity of fluid medium from the small cross sectional area side of said drift tube, and
in a state where an electrical field formed by a field forming means is overlapped in the same direction as the current flow at said slowing flow field, and said ions are present within said slowing flow field by a means for supplying or generating ions, said ions are captured at a position where a drift speed determined by said ionic mobility and intensity of said electrical field, is balanced with a flow speed changing in the direction of current flow; and
after spatially separating ion species of respectively different ionic mobility in said flow direction, and capturing said ions at respective flow direction positions, said captured ions are moved upstream by increasing the intensity of said electrical field and detected by an ion detection means installed upstream of said flow so that ion species with different ion mobility are detected in the order of large ionic mobility on downwards.

6. An ion detection apparatus comprising a drift tube to allow a fluid medium to flow internally and gradually increase the flow path cross sectional area in the direction of said fluid medium flow, and a means for forming an electrical field in the same direction as said fluid medium flow in said drift tube, a means to supply or generate ions in the interior of said drift tube, and a means for detecting ions installed downstream of said fluid medium flow, wherein
a slowing flow field is formed in the interior of said drift tube by flowing a fixed quantity of fluid medium from the small cross sectional area side of said drift tube;
in a state where an electrical field formed by a field forming means is overlapped in the same direction as the current flow at said slowing flow field, and ions are present within said slowing flow field by a means for supplying or generating ions, said ions are captured at a position where a drift speed determined by said ionic mobility and intensity of said electrical field, is balanced with a flow speed changing in the direction of current flow; and
after spatially separating ion species of respectively different ionic mobility in said flow direction, and capturing said ions at respective flow direction positions, said captured ions are moved downstream by decreasing the intensity of said electrical field and detected by an ion detection means installed downstream of said flow so that ion species with different ion mobility are detected in the order of small ionic mobility on upwards.
